(19) United States
(12) Patent Application Publication
(10) Pub. No.: US 2008/0041985 A1
(43) Pub. Date: Feb. 21, 2008

(54) Knife and chopping block holder with ultraviolet lights

(76) Inventor: Chi-Shih Lai, Taipei County (TW)

Correspondence Address: BACON & THOMAS, PLLC, 625 SLATERS LANE, FOURTH FLOOR, ALEXANDRIA, VA, 22314, US

(21) Appl. No.: 11/497,307

(22) Filed: Aug. 2, 2006

(51) Int. Cl. B02C 17/02

(52) U.S. Cl. 241/92

(57) ABSTRACT

A knife and chopping block holder includes a base; a light assembly mounted on the base and including at least one UV light; a power control device mounted on the base; a water guiding and light passing member releasably secured onto the base and including a transparent convex roof for concealing the light assembly, and a drain hole; a drain pan releasably fitted on the base; and a casing releasably secured onto the base and including knife and chopping block storage channels. Water falls from the stored knife and/or the chopping block on the roof. Water then flows from the roof into the drain pan for temporarily storing through the drain hole. Turning on the power control device will cause the UV light to emit UV light rays to kill bacteria present on the knife and/or the chopping block by passing through the roof.

### BACKGROUND OF THE INVENTION

1. Field of Invention

The present invention relates to knife and chopping block holders or racks and more particularly to a knife and chopping block holder having one or more ultraviolet (UV) lights for emitting UV light rays to kill bacteria or viruses that may be present on the knife and/or the chopping block stored therein.

2. Related Art

Knife and chopping block racks (or holders) for storing knives and chopping blocks are well known in the art. In comparison with another typical method of laying loose knives and a chopping block in a kitchen cabinet drawer, the former is relatively neat. But this is unsatisfactory for the purpose for which the invention is concerned for the following reasons: Microorganisms may grow in the rack containing the knives and/or the chopping block, i.e., unsanitary. Further, bugs, ants, or the like may easily enter the rack due to its open structure. Furthermore, water may drop from the knives and/or the chopping block on a kitchen counter top. This is not aesthetic and is also unsanitary. Thus, the need for improvement still exists.

### SUMMARY OF THE INVENTION

It is therefore an object of the present invention to provide a knife and chopping block holder having one or more ultraviolet (UV) lights so as to not only quickly dry the stored knives and/or chopping blocks but also kill bacteria or viruses that may be present thereon.

To achieve the above and other objects, the present invention provides a knife and chopping block holder comprising a base including a compartment at an edge and an opening at one end of a bottom; a light assembly mounted on the base and including at least one UV light; a power control device mounted on the base for controlling on or off of the light assembly; a water guiding and light passing member releasably secured onto the base and including a transparent convex roof for concealing the light assembly, and a drain hole proximate an edge of the roof; a drain pan releasably fitted in the compartment through the opening of the casing and lined up with the drain hole thereabove; and a casing releasably secured onto the base and including a plurality of substantially vertically disposed channels open to the external and the roof; whereby inserting each of at least one knife into a corresponding one of the slots and/or each of at least one chopping block into a different corresponding one of the slots will cause water to fall from the at least one knife and/or the at least one chopping block on the roof, and cause water to flow from the roof into the drain pan for temporarily storing through the drain hole; and turning on the power control device will cause the at least one UV light to emit UV light rays to kill bacteria present on the at least one knife and/or the at least one chopping block by passing through the roof.

The above and other objects, features and advantages of the present invention will become apparent from the following detailed description taken with the accompanying drawings.

### BRIEF DESCRIPTION OF THE DRAWINGS

FIG. 1 is a perspective view of a first preferred embodiment of knife and chopping block holder according to the invention;

FIG. 2 is an exploded perspective view of the knife and chopping block holder;

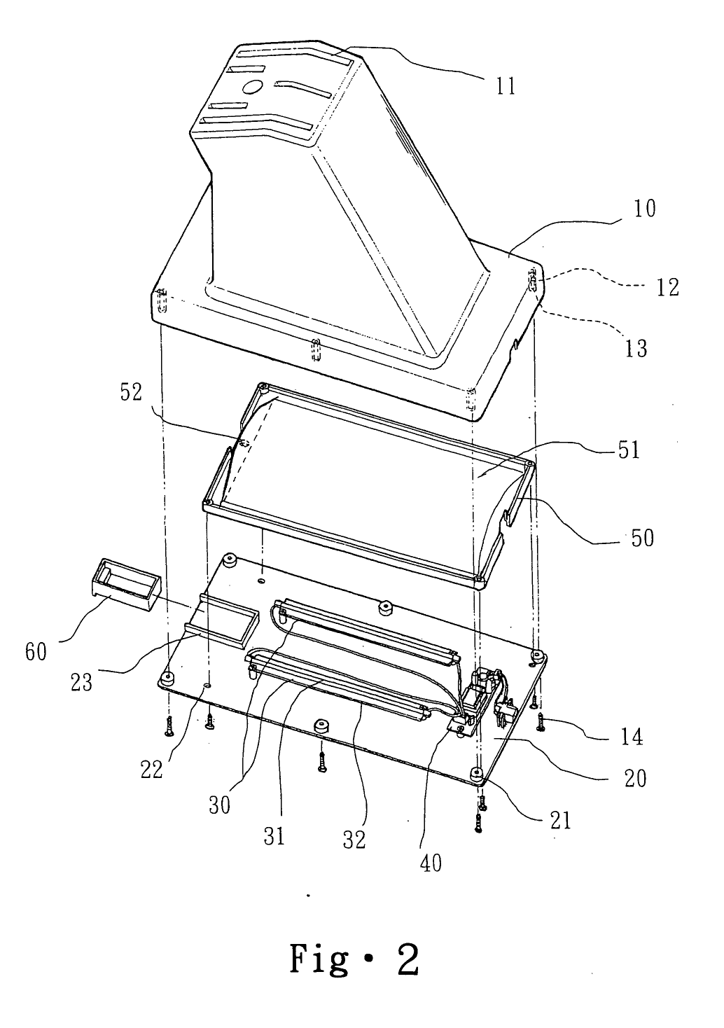

FIG. 3 is another perspective view of FIG. 1 with the casing removed;

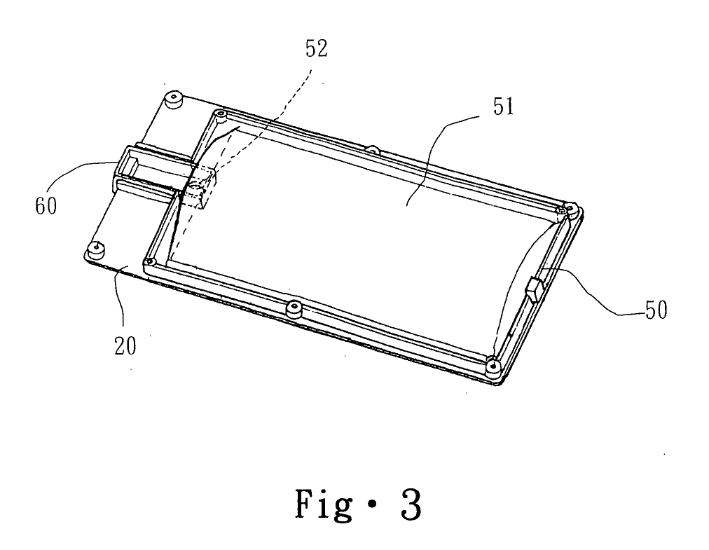

FIG. 4 is a view similar to FIG. 3 with a portion of the roof broken away for showing interior details of the water guiding and light passing member;

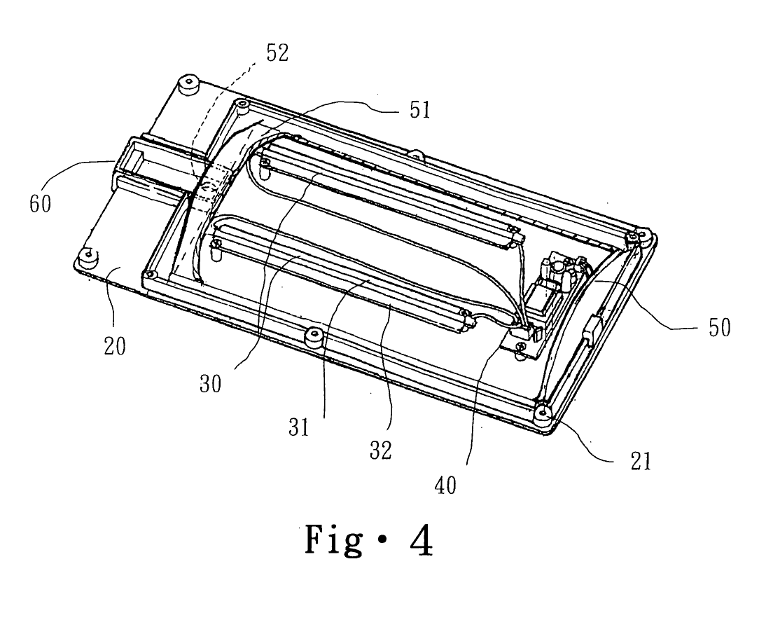

FIG. 5 is an environmental view of the knife and chopping block holder with a knife and a chopping block being stored therein;

FIG. 6 is a perspective view of a second preferred embodiment of chopping block holder according to the invention where the holder being in an open state; and

FIG. 7 is another perspective view of FIG. 6 with the casing removed.

### DETAILED DESCRIPTION OF THE INVENTION

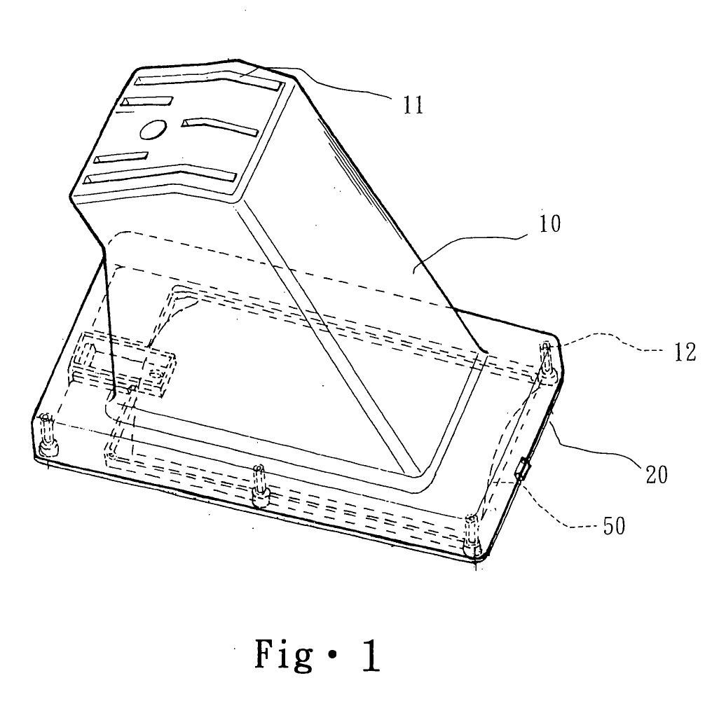

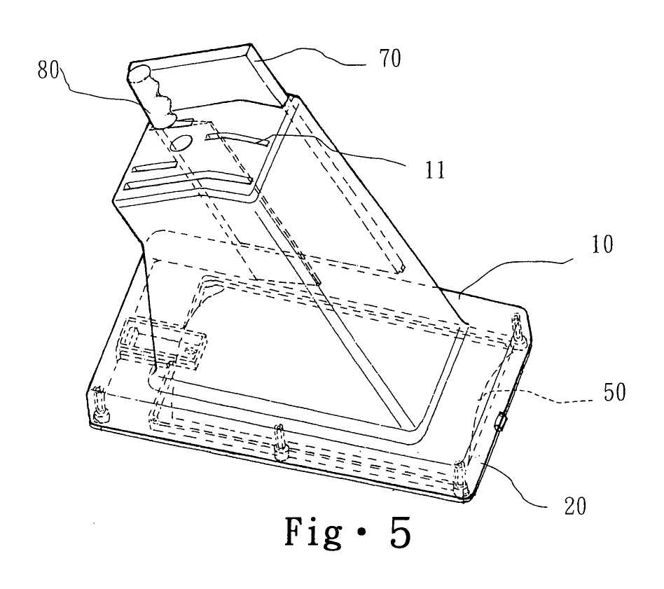

Referring to FIGS. 1 and 5, a knife and chopping block holder in accordance with a first preferred embodiment of the invention is shown. The holder comprises a casing 10, a base 20, two light assemblies 30, a power control device 40, a water guiding and light passing member 50, and a drain pan 60. Each component is discussed in detailed below.

The base 20 is rectangular plate and comprises a plurality of (six) hollow studs 21 along a periphery, a plurality of (four) through holes 22 in which two are proximate two corner studs 21 and the other two are spaced from the other two corner studs 21, and a rectangular compartment 23 at one end.

The casing 10 comprises a plurality of substantially vertically disposed channels 11 having an opening on a top surface and an open bottom end, a plurality of (six) posts 13 along a periphery of an enlarged bottom conformed to the base 20, the post 13 including an internally threaded hole 12, and a plurality of fasteners (e.g., screws) 21 in which one set of fasteners 21 are driven through the studs 21 into the threaded holes 12 of the posts 12 for fastening the base 20 and the casing 10 together, and the other set of fasteners 21 are driven through the holes 22 into a plurality of holes at four corners of the rectangular water guiding and light passing member 50 for fastening the base 20 and the water guiding and light passing member 50 together.

The power control device 40 is mounted on a top surface of the base 20 at the other end. The power control device 40 is electrically connected to an external power source (not shown) through a power cord (not shown). The power control device 40 comprises an on/off switch (not shown) which is adapted to control power of the light assemblies 30.

The two parallel light assemblies 30 are mounted on a top surface of the base 20 between the compartment 23 and the power control device 40. Each of the light assemblies 30 comprises a mount 32 and an ultraviolet (UV) light 31 secured to the mount 32. The UV light 31 is adapted to emit UV light rays having a wavelength of about 251.9 nm.

The rectangular water guiding and light passing member 50 comprises a convex roof 51 formed of a transparent material with the UV lights 31 and the power control device 40 concealed therein, and a drain hole 52 at one end.

The rectangular drain pan 60 is releasably fitted in the compartment 23 through an opening at one end of the bottom of the casing 10 and lines up with the drain hole 52 thereabove.

In operation, first turn on the power control device 40 and then insert, for example, one knife 80 into one smaller slot 11 and one chopping block 70 into one larger slot 11 for storing as shown in FIG. 5 in which both the knife 80 and the chopping block 70 are just washed by clean water. Water falls from both the knife 80 and the chopping block 70 on the smooth outer surface of the roof 51. Next, water flows from the smooth outer surface of the roof 51 into the drain pan 60 for temporarily storing through the drain hole 52. At the same time, the enabled UV lights 31 emit UV light rays to kill bacteria or viruses present on the knife 80 and the chopping block 70 by passing through the roof 51. It is contemplated by the invention that it is possible of not only quickly drying the stored knives and/or chopping blocks but also killing bacteria or viruses that may be present thereon. Further, the holder is substantially a closed container. Hence, bugs, ants, or the like may not easily enter the holder. As a result, the stored knives and/or chopping blocks are sanitary.

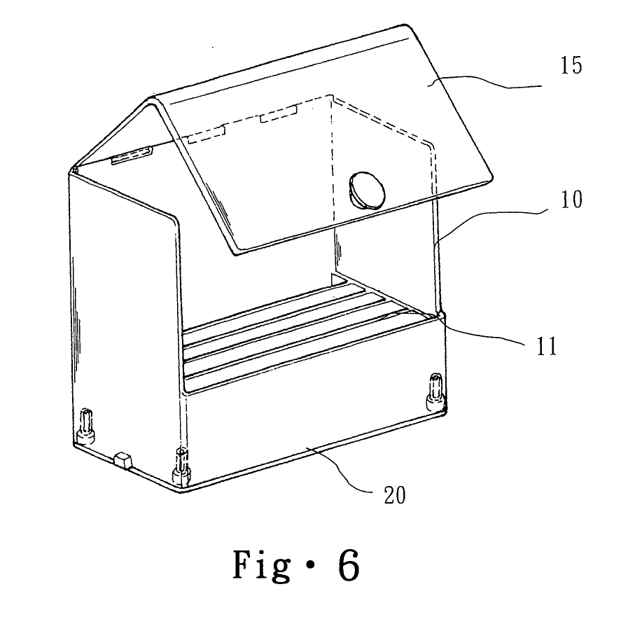

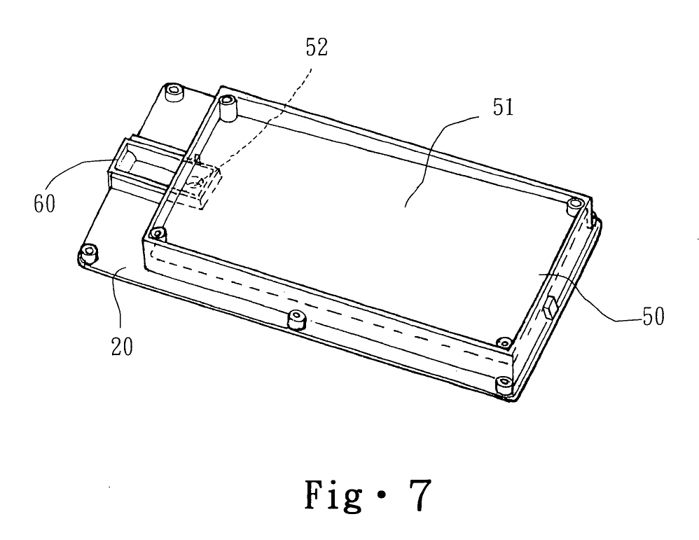

Referring to FIGS. 6 and 7, a second preferred embodiment of the invention is shown. The characteristics of the second preferred embodiment are detailed below. Both the light assemblies 30 and the power control device 40 are eliminated (i.e., no bacteria killing function). The second preferred embodiment is implemented as a parallelepiped chopping block holder only. The casing 10 comprises a hinged cover 15 and a plurality of plurality of vertically disposed channels 11 concealed by the cover 15 in a closed state of the casing 10. The rectangular water guiding member 50 comprises a top slope 51 with the channels 11 disposed thereabove and a drain hole 51 at one end. One or more chopping blocks (not shown) can be inserted into the channel(s) 11 for storage after cleaning. Further, water falls from the chopping block(s) on the smooth slope 51. Next, water flows from the slope 51 into the drain pan 60 for temporarily storing through the drain hole 52.

While the invention herein disclosed has been described by means of specific embodiments, numerous modifications and variations could be made thereto by those skilled in the art without departing from the scope and spirit of the invention set forth in the claims.

What is claimed is:

1. A knife and chopping block holder comprising:
a base including a compartment at an edge and an opening at one end of a bottom;
a light assembly mounted on the base and including at least one ultraviolet (UV) light;
a power control device mounted on the base for controlling on or off of the light assembly;
a water guiding and light passing member releasably secured onto the base and including a transparent convex roof for concealing the light assembly, and a drain hole proximate an edge of the roof;
a drain pan releasably fitted in the compartment through the opening of the casing and lined up with the drain hole thereabove; and
a casing releasably secured onto the base and including a plurality of substantially vertically disposed channels open to the external and the roof;
whereby inserting each of at least one knife into a corresponding one of the slots and/or each of at least one chopping block into a different corresponding one of the slots will cause water to fall from the at least one knife and/or the at least one chopping block on the roof, and cause water to flow from the roof into the drain pan for temporarily storing through the drain hole; and turning on the power control device will cause the at least one UV light to emit UV light rays to kill bacteria present on the at least one knife and/or the at least one chopping block by passing through the roof.
